(19) United States
(12) Patent Application Publication
(10) Pub. No.: US 2019/0095409 A1
(43) Pub. Date: Mar. 28, 2019

(54) SCRATCHWORK WEBCAM SCAN FEATURE

(71) Applicant: Scratchwork LLC, Princeton, NJ (US)

(72) Inventor: John Stogin, State College, PA (US)

(73) Assignee: Scratchwork LLC, Princeton, NJ (US)

(21) Appl. No.: 16/141,420

(22) Filed: Sep. 25, 2018

Related U.S. Application Data
(60) Provisional application No. 62/563,429, filed on Sep. 26, 2017.

(51) Int. Cl. G06F 17/24; G06F 17/21; G06T 7/194

(52) U.S. Cl. CPC G06F 17/241; G06T 7/194; G06F 17/211

(57) ABSTRACT

A system and method for capturing and digitally representing hand-drawn annotations from non-digital media such as paper or a whiteboard. The system and method involve taking an image of the annotations and then processing the image to determine the shapes defined by spatially connected pixels. These shapes can then be treated (eg. selected, resized, moved, copied, deleted, etc.) as atomic units and used in a document editing or digital communication setting. This system does not require any pre-defined set of characters, symbols, or shapes.

### CROSS-REFERENCE

This application claims the benefit of U.S. Provisional Application No. 62/563,429, filed Sep. 26, 2017, which application is incorporated herein by reference.

### BACKGROUND OF THE INVENTION

Current collaborative communication over the internet and other digital platforms is limited when it comes to sharing hand drawn items. Non-digital drawing media, such as pen-and-paper, are often preferred over digital media for expressing concepts such as equations and diagrams. However, digital media are significantly better suited for editing and collaborative communication. A common approach is to use a camera or scanner to digitize paper drawings as a static image to be shared over the Internet. The sharer shares the drawing, written words, or whatever else is on the whiteboard, piece of paper, or other item, and the contents are shared as a whole. Collaborators are not able to easily move the individualized drawings or characters on the shared image despite the objects not touching each other on the medium. This shortfall limits the collaboration that can be completed when communication stems from a hand written or non-digitized medium. One remedy is to recognize the meaning of the digitized drawings and replace them with the digital characters they represent. However, this approach requires a prior knowledge of what the user intends to draw and can lead to user frustration resulting from mis-classification.

The disclosed system provides the improved ability to take notes, share, learn, and otherwise collaboratively communicate ideas from a range of devices, such as smartphones, tablets, computers, video conferencing systems, or similar. The disclosed system describes a new way to represent non-digital drawings on a digital medium so that they can be individually selected, moved, copied, and shared. Importantly, the system disclosed does not rely on recognition software that will require that every symbol belong to a pre-determined database.

### SUMMARY OF THE INVENTION

In some embodiments, a collaborative communication system made up of a plurality of user devices including a display and a camera, a processing unit, wherein the processing unit is configured to receive an image originating from at least one camera, and further configured to convert the image into a greyscale image comprising a plurality of pixels whose value with a higher value correspond to elements that are darker than their nearby background, wherein the processing unit is further configured to generate a first array by comparing the value of each of the plurality of pixels to a first threshold, setting values above the first threshold to a first value and setting values below or equal to the first threshold to a second value, and wherein the processing unit is further configured to generate a second array defining connected components by identifying a first member of the first array set to the second value that is connected to less than a second threshold number of other members of the first array set to the second value, and converting the value of the first member to the first value. In some embodiments, the image is placed on a virtual board such that pixels in the image corresponding to connected components become individual items that are capable of being manipulated by a user interacting with the virtual board on one of the plurality of user devices. In some embodiments, the first threshold is determined by the processing unit based on the greyscale image. In some embodiments, the second threshold is between 2 and 10. In some embodiments at least one of the plurality of user devices further comprises an audio input. In some embodiments, symbols retrieved through the system are viewable in real time by collaborators outside of just the original drawer. In some embodiments, the images on the virtual board are capable of being at least one of selected, resized, manipulated, equated, or converted to a different format. In some embodiments, the processing unit converts an image into a LaTeX formatted object. In some embodiments, the first value is white and the second value is black. In some embodiments, the symbols extracted can be erased as a unit or drawn on top of electronically on a virtual whiteboard. In some embodiments, the symbols are able to be placed on top of other digital content, wherein if a background is removed, only the symbol itself obstructs the other digital content.

A method of image extrapolation, including receiving a first image, converting the image into a greyscale image, generating a first array by comparing the value of each of the plurality of pixels to a first threshold, setting values above the first threshold to a first value and setting values below or equal to the first threshold to a second value, generating a second array defining connected components by identifying a first member of the first array set to the second value that is connected to less than a second threshold number of other members of the first array set to the second value, and converting the value of the first member to the first value, and placing the image on a virtual board such that pixels in the image corresponding to connected components become individual items that are capable of being manipulated by a user interacting with the virtual board on one of the plurality of user devices. In some embodiments, all users in collaboration can edit the deposited image.

A method of image extrapolation, including capturing an image, reverse greyscaling the image, assigning a numerical value related to a pixel's shade in the black to white spectrum, establishing a threshold, converting pixels above threshold to black or another color and pixels below the threshold to transparent, eliminating black or other colored pixels that are connected to fewer than a given threshold of pixels, and placing leftover symbols onto a virtual whiteboard, wherein said symbols are editable. In some embodiments, the digitized symbols are able to be resized independently. In some embodiments, the digitized symbols are removable independently of other symbols in a same original image. In some embodiments, all steps of the method are computer automated. In some embodiments, a digitized symbol is movable independently of other symbols.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 is an exemplary illustration of the webcam capture of a signature and date.

FIG. 2 is an exemplary illustration of a captured signature and date being placed on a form.

FIG. 3 is an exemplary illustration of the webcam capture of formulas and drawings.

FIG. 4 is an exemplary illustration of the captured formulas and drawings being placed on a virtual board.

FIG. 5 is an exemplary illustration of the separation of different aspects of a captured image.

FIG. 6 is an exemplary illustration of the webcam feature before capture including separate aspects.

FIG. 7 is an exemplary illustration of the captured image before board placement.

FIG. 8 is an exemplary screen capture of a pre-webcam capture of formulas and drawings.

FIG. 9 is an exemplary screen capture of hand-drawn formulas and drawings on a virtual board.

FIG. 10 is an exemplary illustration of the system's aspect movement.

FIG. 11 is an exemplary illustration of the system's aspect movement and scaling features.

FIG. 12 is an exemplary scan of a hand drawn sheet used for demonstration of the system.

### DETAILED DESCRIPTION OF THE INVENTION

The system described herein can be used for digitizing hand drawings on a non-digital medium. The digitization of these drawings can be done via a three-step approach. First, the image can be captured via a camera (e.g. a webcam or other image extracting device). Second, the image will be treated in a grid like function judging points through pixels and two-dimensional ordered pairs. In some embodiments, the first step will be to reverse greyscale the image. The reverse greyscale process can take the original red green blue image, and extract the bitmap data to reassign the colors to a greyscale spectrum (e.g., a greyscale spectrum from 0 to 255, where zero is completely white and 255 is completely black). In some embodiments, the spectrum is made up of other color separation (i.e. red and green or other color sets, where the process focuses on separating red and green pixels from each other and from the background). The reverse greyscale image can be processed. In some embodiments, the program can assign a threshold through analyzing whitespace, line density, and/or other possible factors to capture the data being extracted. The threshold in some embodiments relies on a histogram. In some embodiments, the threshold is determined from the histogram using Otsu's Method. The threshold can be obtained through one histogram or multiple. The processing step can take the scale spectrum introduced in the reverse greyscale step, and the system can take all pixels below the threshold and turn the pixels white, while all pixels above the threshold can be turned black. In some embodiments, the processing step is encompassed by background subtraction. The background subtraction can help eliminate problems related to shadows. The background can be determined by a maximum filter, which is less likely to be affected by the user's drawings compared to a median filter. The process can also include a post-processing step, which involves removing markings under a threshold amount of connected pixels. The system can analyze all black pixels and determine whether the pixels are connected either vertically, horizontally, and/or diagonally to a certain threshold number of pixels. If the certain threshold of connected pixels is not achieved, the pixels can be turned white. The purpose of the post-processing step can be to reduce or eliminate small, disconnected, artifacts from the image. Third and finally, each set of spatially connected pixels can be considered as an individual atomic unit (much like a text character or shape) and can be selected, moved, resized, and/or deleted individually.

Users can take notes in a variety of ways, including simply taking notes on traditional paper. The disclosed system can gather the notes (e.g. by webcam), and process them onto a virtual board. The processing can also include voice and video collaboration, (e.g., the gathering of the notes would be completed through a webcam, phone camera, or some other device that captures a picture). The system will use algorithms to retrieve the symbols and place the retrieved data on the virtual board for personal use along with collaborative use.

After an image is captured, the system can convert the image. Conversion of an image can be described as occurring in three phases: (i) preprocessing, (ii) processing, and (iii) post-processing. The preprocessing phase turns the captured image into a reverse greyscale image with uniform background intensity (ie. with the background shadows removed from the image). In some embodiments, this involves pixels with a higher value corresponding to elements that are darker than their nearby background. The differentiation between the darker pixels and lighter pixels with the darker pixels being recognized is referred to as reverse greyscale. The processing step can take the greyscale image, and convert the greyscale image to binary data, based on whether or not the value of each pixel in the greyscale image is above or below a threshold. The resulting image is only black and white with all variation of grey being changed to either the black or the white based on the threshold set. The threshold may be determined in a variety of ways, including simply being selected by a user, although preferred embodiments utilize a determination made by the algorithm during the pre-processing step. The post-processing phase identifies pixels that are connected to each other, and allows each connected set of pixels to be considered as a single element. The connections can be diagonally, horizontally, or vertically. Connected elements are typically left as black, and all pixels that do not meet the threshold are changed to white or transparent. This post-processing phase attempts to eliminate some of the smaller artifacts from the image by setting the threshold of what is considered a connected group to a value greater than zero. Reasonable integers can generally be between 2 and 10, inclusive. Some embodiments will find optimal retrieval around 6, although various settings or uses may find other values acceptable. In not taking the digitized image to a recognition step, the symbols may not be misrecognized leading to confusion and frustration.

In some embodiments, the digitized symbols are able to be placed on top of other digital content, and only the symbol itself obstructs the other digital content.

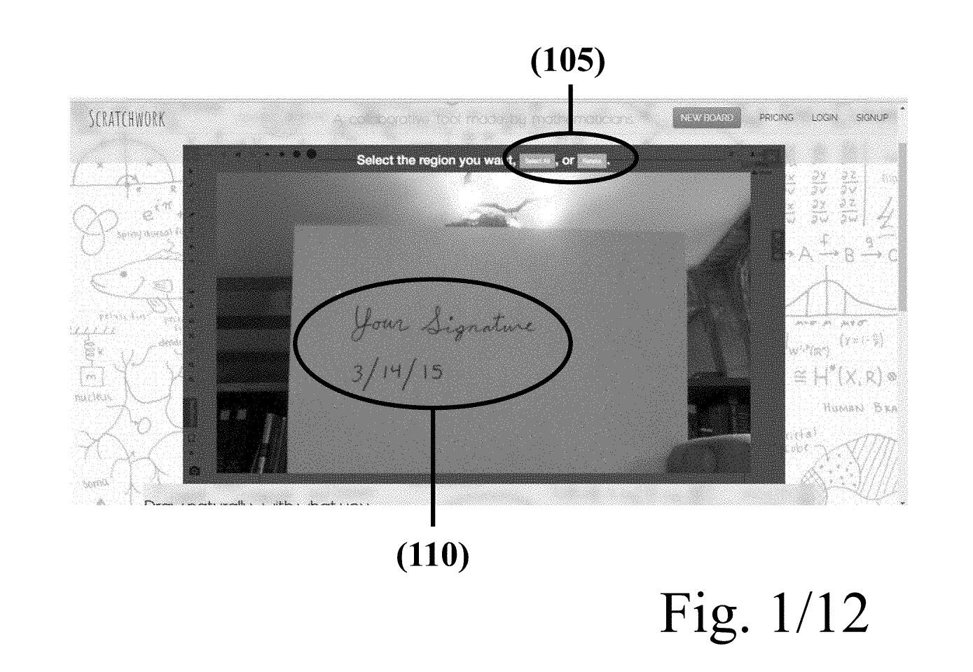

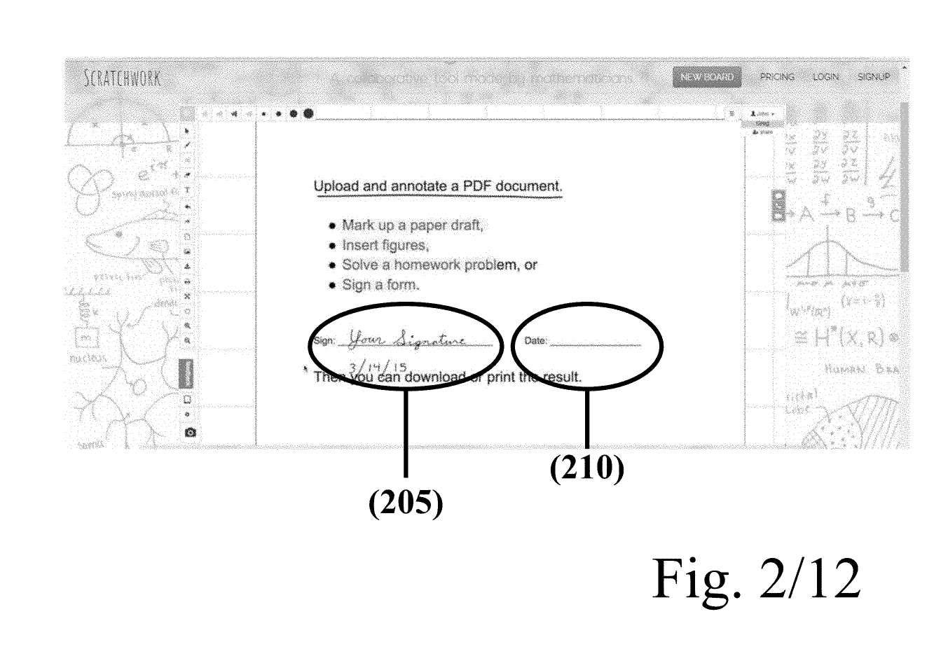

FIGS. 1 and 2 convey an embodiment of the system being utilized to place a hand-written signature and date onto a form. FIG. 1 shows the capture of the hand-written signature and date (110) through a webcam. Once captured, the user is given the option to select a section of the image, to select all, or to retake (105). In FIG. 2, the captured hand-written signature and date (110) (205) of FIG. 1 is placed on a form. The user or a collaborator can then select only the date (eg. by dragging a selection box around it) and move the date from (205) to (210).

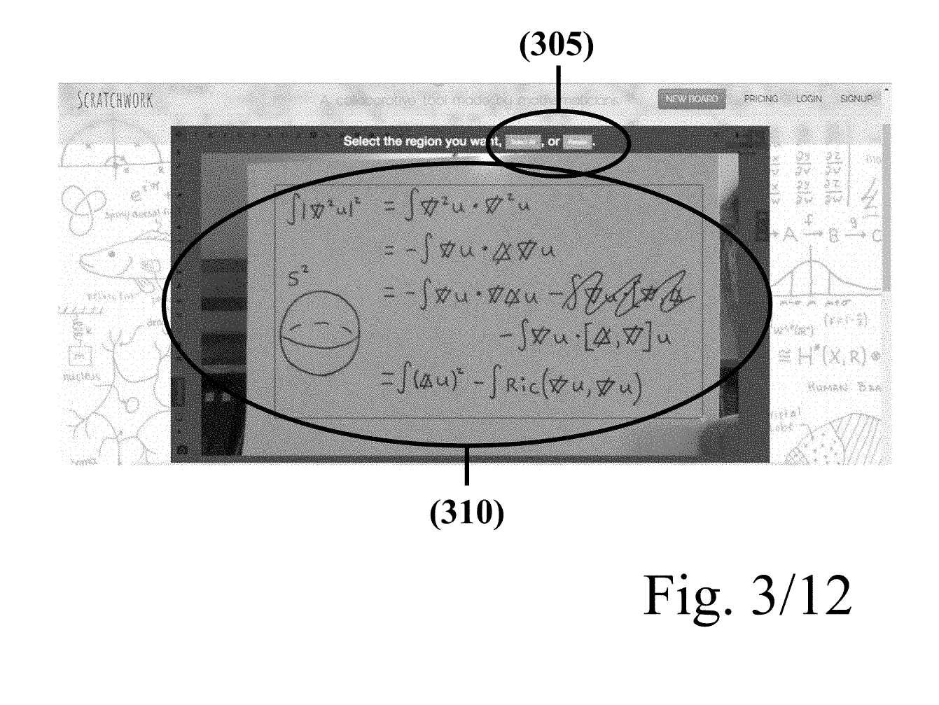

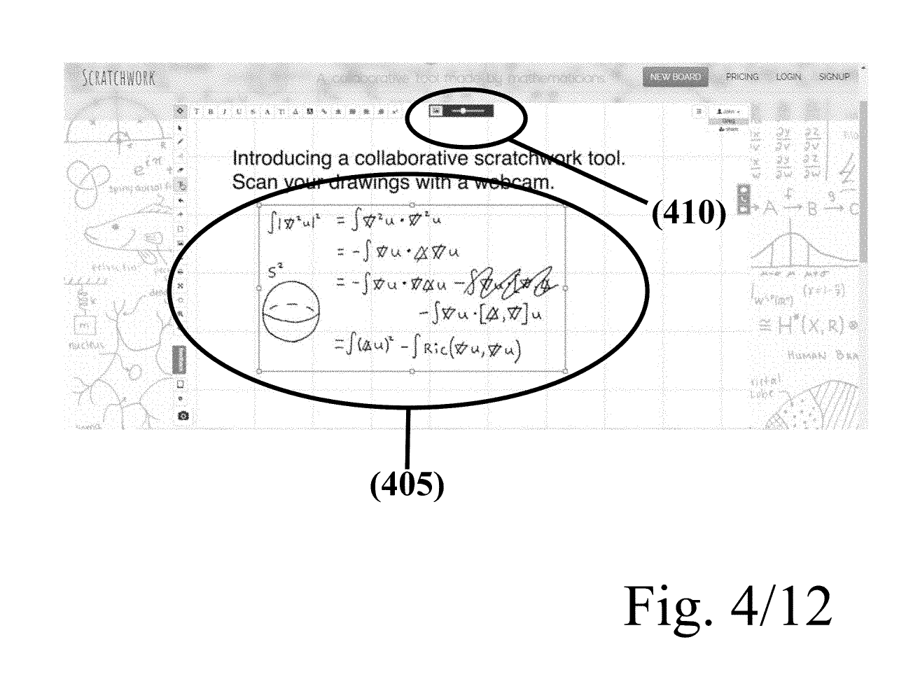

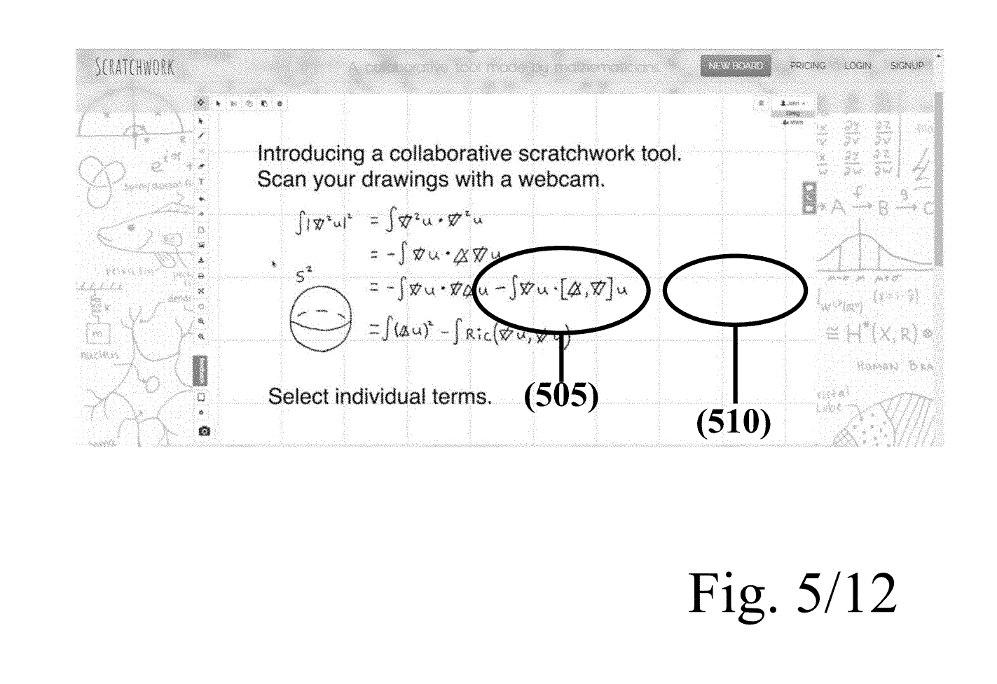

FIGS. 3, 4, and 5 portray the system utilized to digitize hand-written formulas and figures along with the ability to edit the formulas and figures on a virtual whiteboard. FIG. 3 conveys the ability of the system to capture the image (310) with the options to select all or retake (305). In FIG. 4, the image (310) is placed on the virtual whiteboard (405). The image can be resized in multiple ways including the resizing bar (410). FIG. 5 displays how the system can be used to delete unwanted parts of an image (510), along with the ability to move symbols (505).

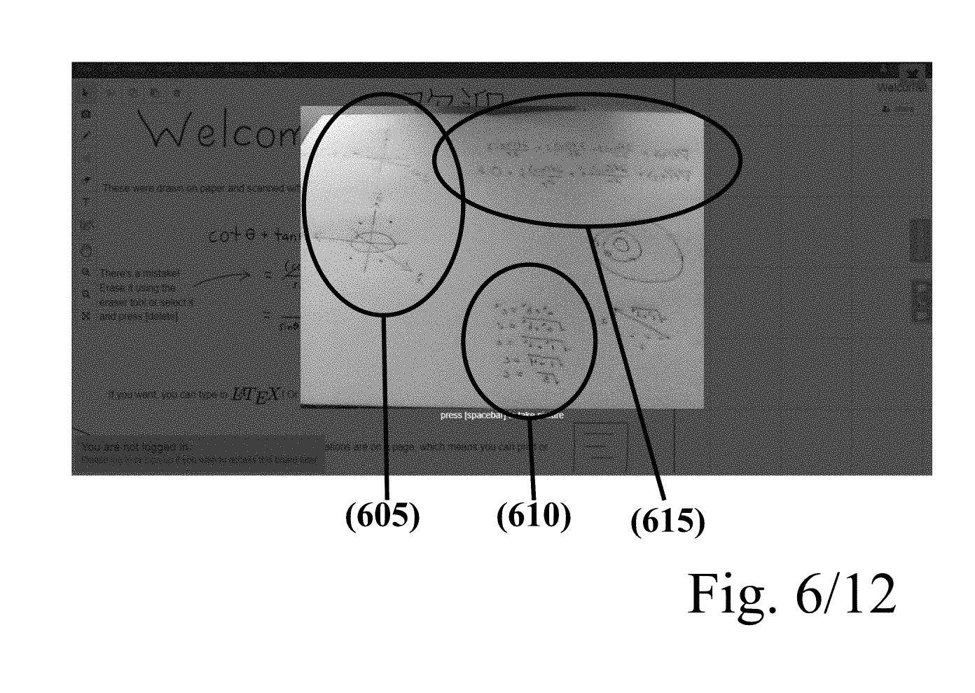

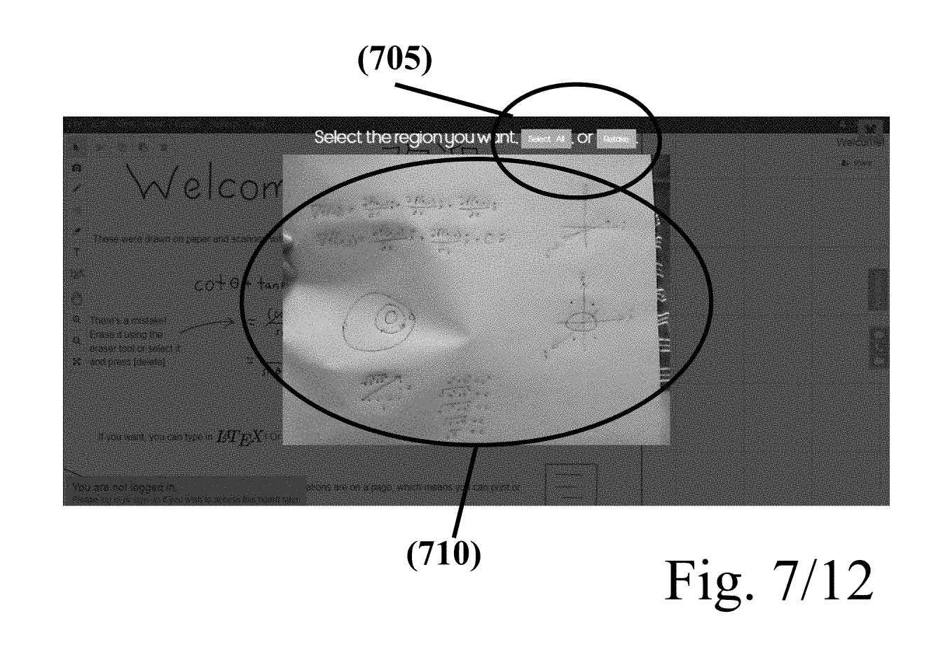

FIGS. 6 and 7 convey an embodiment of the system capturing an image with various formulas and drawings. FIG. 6 shows four separate sections including sections (605) (610) (615). FIG. 7 shows how in this embodiment the image can be flipped (710) once captured, including all aspects captured with the option to individually select, select all, and/or retake (705).

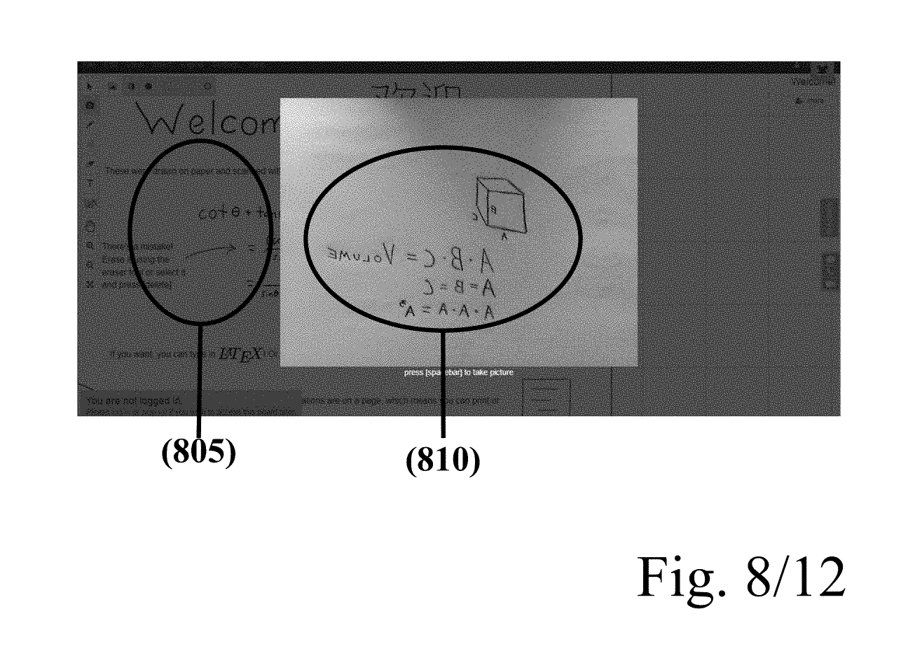

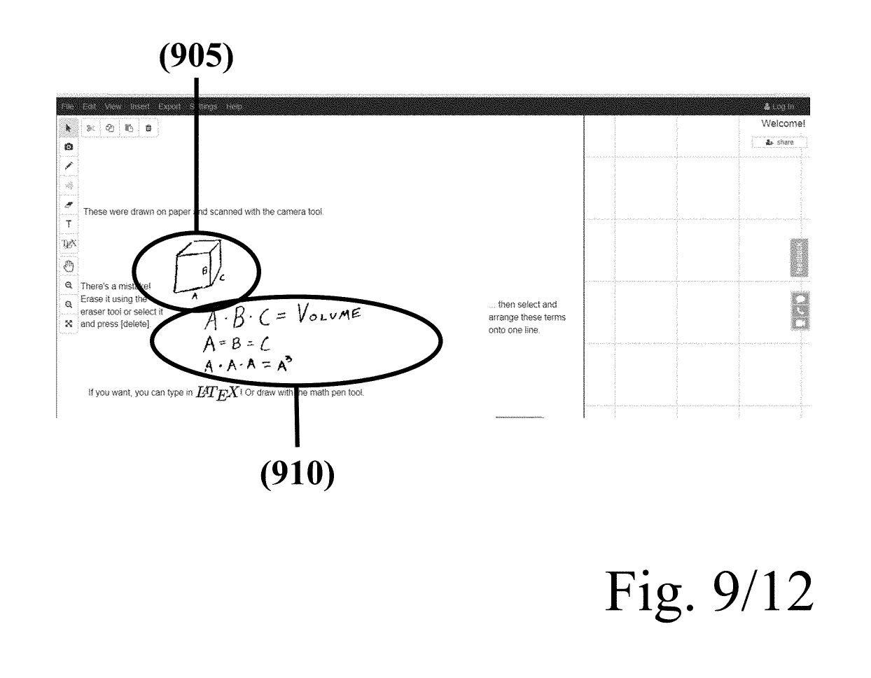

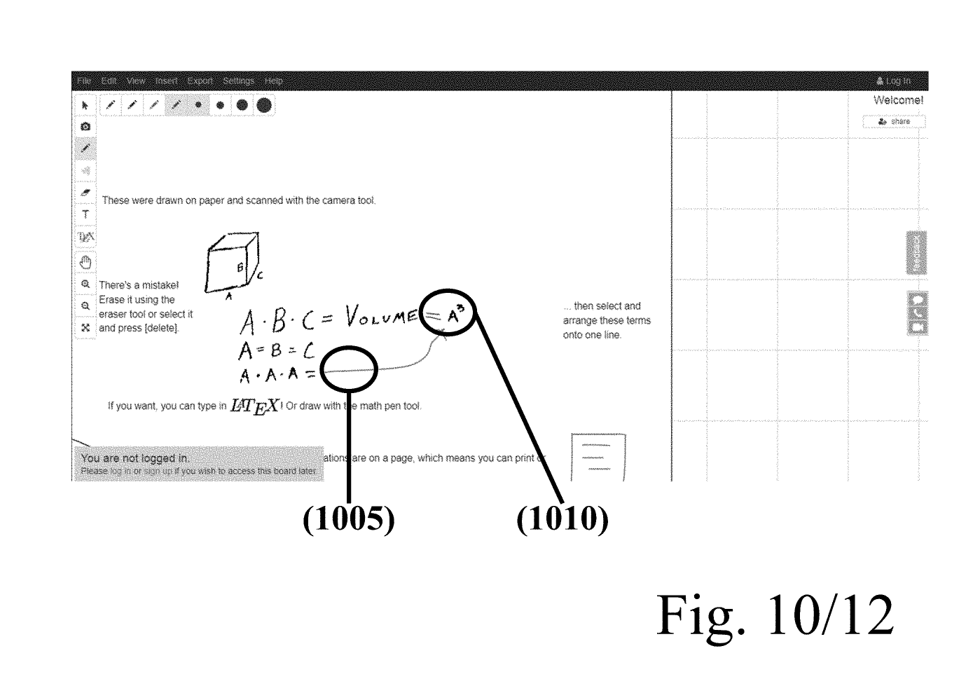

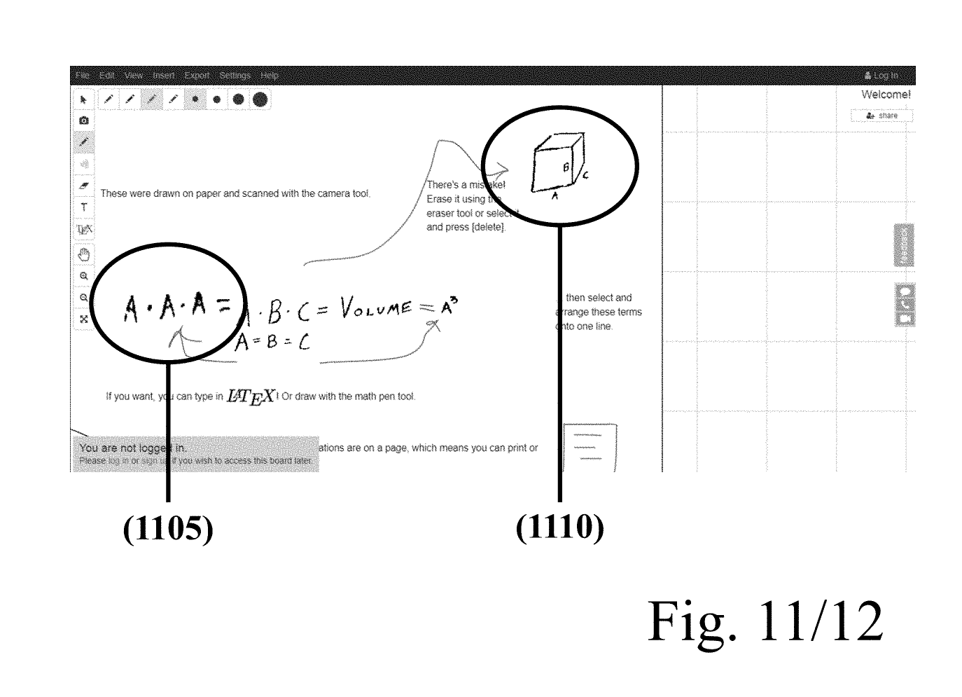

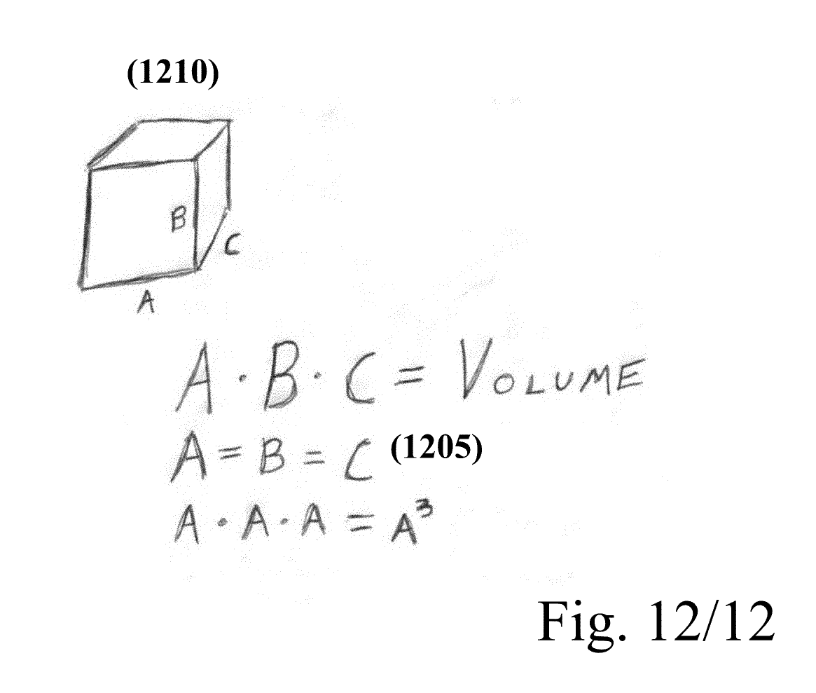

FIGS. 8, 9, 10, 11, and 12 portray the system being utilized to digitize a hand-written page and edit the digitized page on the virtual whiteboard. FIG. 12 depicts the hand-written page that was digitized. The hand-written page consists of two main parts: the formulas (1205) and the drawn FIG. 1210). The hand-written page can be captured, reverse greyscaled, processed, post processed, and/or placed on a virtual whiteboard. FIG. 8 portrays the two parts, the cube and the formulas, (810) being captured by the system, ready to be placed on a virtual whiteboard (805). In FIG. 9, the system has placed a captured image on the virtual whiteboard after the pre-processing phase, processing phase, and the post processing phase. The drawn FIG. 905) and the formulas (910) can be moved, deleted, and scaled separately. Along with the drawings and formulas being separated, the different parts to the formulas can be movable, as depicted in FIG. 10. An answer, depicted as “A³” can be moved by the user from (1005) to (1010). FIG. 11 shows the utilization of several features, including: resizing and moving symbols. Part of the formula is moved by the user and resized (1105), while the drawn FIG. 1110) is moved by the user away from the formula on the virtual whiteboard.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A collaborative communication system comprising:
a plurality of user devices including a display and a camera;
a processing unit;
wherein the processing unit is configured to receive an image originating from at least one camera, and further configured to convert the image into a greyscale image comprising a plurality of pixels whose value with a higher value correspond to elements that are darker than their nearby background;
wherein the processing unit is further configured to generate a first array by comparing the value of each of the plurality of pixels to a first threshold, setting values above the first threshold to a first value and setting values below or equal to the first threshold to a second value; and
wherein the processing unit is further configured to generate a second array defining connected components by identifying a first member of the first array set to the second value that is connected to less than a second threshold number of other members of the first array set to the second value, and converting the value of the first member to the first value.

2. A system according to claim 1, wherein the image is placed on a virtual board such that pixels in the image corresponding to connected components become individual items that are capable of being manipulated by a user interacting with the virtual board on one of the plurality of user devices.

3. The system according to claim 1, wherein the first threshold is determined by the processing unit based on the greyscale image.

4. The system according to claim 1, wherein the second threshold is between 2 and 10.

5. The system according to claim 1, wherein at least one of the plurality of user devices further comprises an audio input.

6. The system according to claim 1, wherein symbols retrieved through the system can be viewed in real time by collaborators outside of just the original drawer.

7. The system according to claim 1, wherein the images on the virtual board are capable of being at least one of selected, resized, manipulated, equated, or converted to a different format.

8. The system according to claim 7, wherein the processing unit converts an image into a LaTeX formatted object.

9. The system according to claim 1, wherein the first value is white and the second value is black.

10. The system according to claim 1, wherein the symbols extracted can be erased as a unit or drawn on top of electronically on a virtual whiteboard.

11. The system according to claim 1, wherein the symbols are able to be placed on top of other digital content, wherein if a background is removed, only the symbol itself obstructs the other digital content.

12. A method of image extrapolation, comprising:
receiving a first image;
converting the image into a greyscale image;
generating a first array by comparing the value of each of the plurality of pixels to a first threshold, setting values above the first threshold to a first value and setting values below or equal to the first threshold to a second value;
generating a second array defining connected components by identifying a first member of the first array set to the second value that is connected to less than a second threshold number of other members of the first array set to the second value, and converting the value of the first member to the first value; and
placing the image on a virtual board such that pixels in the image corresponding to connected components become individual items that are capable of being manipulated by a user interacting with the virtual board on one of the plurality of user devices.

13. A method as in claim 12, wherein all users in collaboration can edit the deposited image.

14. A method of image extrapolation, comprising:
capturing an image;
reverse greyscaling the image;
assigning a numerical value related to a pixel's shade in the black to white spectrum;
establishing a threshold;
converting pixels above threshold to black or another color and pixels below the threshold to transparent;
eliminating black or other colored pixels that are connected to fewer than a given threshold of pixels; and
placing leftover symbols onto a virtual whiteboard, wherein said symbols are editable.

15. A method as in claim 14, wherein the digitized symbols are able to be resized independently.

16. A method as in claim 14, wherein the digitized symbols are removable independently of other symbols in a same original image.

17. A method as in claim 14, wherein all steps of the method are computer automated.

18. A method as in claim 14, wherein a digitized symbol is movable independently of other symbols.
